(19) United States
(12) Patent Application Publication
(10) Pub. No.: US 2004/0042444 A1
(43) Pub. Date: Mar. 4, 2004

(54) Voice over internet protocol service through broadband network

(75) Inventors: Eugene Lane Edmon, Danville, CA (US); Goangshiuan Shawn Ying, Oakland, CA (US)

Correspondence Address: GREENBLUM & BERNSTEIN, P.L.C., 1950 ROLAND CLARKE PLACE, RESTON, VA, 20191, US

(73) Assignee: SBC Properties, L.P., Reno, NV

(21) Appl. No.: 10/288,522

(22) Filed: Nov. 6, 2002

Related U.S. Application Data
(63) Continuation of application No. 10/228,068, filed on Aug. 27, 2002.

(51) Int. Cl. H04L 12/66

(52) U.S. Cl. 370/352; 370/356; 370/395.1

(57) ABSTRACT

A voice communication occurs between a subscriber terminal and a called party terminal through a public switched telephone network (PSTN) or Internet protocol (IP) network. A gateway receives at least one digital voice packet from the subscriber terminal through a local loop, the voice packet including voice data, a context identifier (CID) associated with the voice packet based on a local loop protocol, and no packet header. The gateway maps the CID to a communication session and adds a packet header, which includes routing information based on the mapped CID. The gateway forwards the voice packet to the IP network for routing to the called party terminal based on the packet header. A gateway controller may determine whether to route the call through the PSTN or the IP network based on whether a number of the called party terminal has an associated IP address.

This is a continuation of U.S. patent application Ser. No. 10/228,068, filed Aug. 27, 2002, and pending before the U.S. Patent and Trademark Office.

### BACKGROUND OF THE INVENTION

### FIELD OF THE INVENTION

The present invention relates to the field of telecommunications. More particularly, the present invention relates to efficiently establishing voice over Internet protocol (IP) connections over a broadband network.

### ACRONYMS

The written description provided herein contains acronyms which refer to various telecommunications services, components and techniques, as well as features relating to the present invention. Although some of these acronyms are known, use of these acronyms is not strictly standardized in the art. For purposes of the written description, the acronyms are defined as follows:

Adaptive Differential Pulse Code Modulation (ADPCM)

Advanced Intelligent Network (AIN)

Asynchronous Transfer Mode (ATM)

Asymmetrical Digital Subscriber Line (ADSL)

ATM Adaption Layer 2 (AAL2)

Broadband Loop Emulated Service (BLES)

Channel Associated Signaling (CAS)

Common Channel Signaling (CCS)

Digital Subscriber Line (DSL)

Digital Subscriber Line Access Multiplexer (DSLAM)

Dual Tone Multiple Frequency (DTMF)

Integrated Services Digital Network (ISDN)

Intermachine Trunk (IMT)

International Telecommunications Union (ITU)

Internet Protocol (IP)

Interworking Function (IWF)

Local Area Network (LAN)

Local Exchange Carrier (LEC)

Personal Computer (PC)

Plain Old Telephone Service (POTS)

Public Switched Telephone Network (PSTN)

Pulse Code Modulation (PCM)

Request for Comment (RFC)

Quality of Service (QoS)

Realtime Transport Protocol (RTP)

Real-Time Variable Bit Rate (rt-VBR)

Time Division Multiplex (TDM)

Trunk Level 1 (T1)

User Datagram Protocol (UDP)

Virtual Channel Identifier (VCI)

Virtual Path Identifier (VPI)

Voice Over Internet Protocol (VoIP)

Wide Area Network (WAN)

### BACKGROUND INFORMATION

A typical telecommunications network includes a plain old telephone service (POTS) line connecting a subscriber's terminal, such as a dual tone multiple frequency (DTMF) telephone, to a central office (CO) operated by a local exchange carrier (LEC) in a public switched telephone network (PSTN). The connection between the subscriber's terminal and the CO, called a local loop, copper loop or a local access network, typically includes a twisted pair of copper wires. Use of a POTS line limits bandwidth immediately available to the subscriber, even when the CO interfaces with a broadband digital network, such as an asynchronous transfer mode (ATM) network, because of attenuation in the transmission line.

To fully enjoy the benefits of the broadband digital network, subscribers must minimize or bypass the limitations of POTS using, for example, digital subscriber line (DSL), integrated services digital network (ISDN) or cable modem services, which transmit digitized signals. The DSL and ISDN services, in particular, enable digital communications and broadband access through the local loop, as well as the core network.

Digital voice signals may be packetized according to an internet protocol (IP) and routed through an IP network, which is known as voice over IP (VoIP). VoIP is conventionally implemented using a digital communications medium, such as a personal computer (PC) or an IP telephone, which generates digital voice packets transmitted over the local loop to the core IP network. Alternatively, VoIP may be implemented using an analog DTMF telephone, connected to an IP adapter or a digital modem, which converts the analog signals to digital signals and packetizes the digital signals for transmission. A related packet based voice communications service is voice over DSL (VoDSL), which includes a VoDSL telephone that packetizes digital voice signals to be transmitted over the local loop. However, the voice packets are ultimately converted into time division multiplex (TDM) signals, which are forwarded to the PSTN for connection to the called party.

In order to provide useable VoIP services, the LEC must assure a certain level of voice quality, also known as a guaranteed quality of service (QoS), which includes minimizing delay, packet loss and jitter. Certain delays are inherent in IP network communications, such as digitally encoding analog voice signals, packetizing the digitized voice data, transmitting voice packets over the local access and core networks, and buffering the received voice packets (e.g., jitter buffering). Voice transmissions are especially sensitive to such delays because the natural flow of conversation suffers with excessive delays or lost information, caused by inadequate attempts to avoid delays, such as insufficient buffering.

To enhance voice communication quality, conventional packet configurations may include significant overhead, such as full core network headers and Ethernet overheads, associated with the voice packets. For example, the core network header may include the combined overhead of IP, user datagram protocol (UDP) and realtime transport protocol (RTP) associated with the voice packet, known as an IP/UDP/RTP header.

A typical IP/UDP/RTP header occupies 40 bytes of a data packet. The IP header portion includes a source IP address, a destination IP address, a header check sum and identification of the underlying transport layer protocol, such as UDP. UDP offers minimal transport functionality over IP. The UDP header includes source and destination port numbers, as well as data check sums. RTP provides functionality for enabling real-time content, and includes timestamps, sequence numbers and various control mechanisms for synchronizing data streams with timing properties. Typically, RTP is associated with UDP.

The overhead necessarily reduces the portion of each packet dedicated to payload (e.g., the digital voice data), and consequently occupies a significant portion of available bandwidth that would otherwise be able to carry the voice data. Increasing the bandwidth available to a VoIP session improves the QoS, but may unduly burden the system, with respect to contemporaneous users. Moreover, the network simply may not be able to provide the necessary bandwidth, especially on the local loop. For example, asymmetrical DSL (ADSL) based broadband access networks have a very limited upstream capacity (from the subscriber location toward the network) with respect to bandwidth. Also, the conventional line efficiency of ADSL is low and is more appropriately directed to internal or local VoIP networks, as opposed to a broader wide area network (WAN).

A number of efforts have been made to avoid excessive proportions of overhead in voice packets. For example, the length of the voice packets may be increased, to as much as 40 milliseconds, to reduce the proportion of overhead to voice data. However, longer voice packets increase packetization and jitter buffer induced delays. Also, headers may be compressed by removing unchanging or constant parameters, for example. However, compression may induce a different set of efficiency problems, such as difficulty in error detection.

The present invention overcomes the problems associated with the prior art, as described below.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is a block diagram showing an exemplary telecommunications network supporting VoIP, according to an aspect of the present invention;

FIG. 2 is a flowchart of exemplary application logic for selecting a network to interface an outgoing communication, according to an aspect of the present invention;

FIG. 3 is a flowchart of exemplary application logic for routing outgoing VoIP communications through a media gateway, according to an aspect of the present invention; and

FIG. 4 is a flowchart of exemplary application logic for routing incoming VoIP communications through a media gateway, according to an aspect of the present invention.

### DETAILED DESCRIPTION OF EMBODIMENTS

The present invention relates to increasing bandwidth and line efficiency to enable quality voice communications over broadband networks, including guaranteed QoS of VoIP functionality for ADSL subscribers. The invention is directed to providing a process for delivering high quality VoIP service through an ADSL access network, using a modified broadband loop emulated service (BLES) protocol over an ATM Adaption Layer 2 (AAL2) based ATM network. The local access network interfaces with the appropriate core network, such as an IP network or a public switched telephone network (PSTN), through a multi-media gateway, to connect the subscriber to a destination terminal or end-system.

More particularly, digital voice packets are transmitted across a local access loop, without IP/UDP/RTP headers, to the media gateway, where a controller determines whether to direct the call over the IP network or the PSTN. When the call is directed over the IP network, the media gateway adds the necessary headers and routes the voice packets accordingly. When the call is directed over the PSTN, the media gateway converts the voice packets to TDM voice signals and transmits the voice signals to a CO.

In view of the above, the present invention through one or more of its various aspects and/or embodiments is presented to accomplish one or more objectives and advantages, such as those noted below.

An aspect of the present invention provides a method for increasing efficiency in a first communications network for a digital data packet originating at a subscriber end-system. The first communications network interfaces with a second communications network through an interworking function (IWF) device. The first communications network may be an ATM network and the second communications network may be a packet switched data network. The method includes receiving the packet at the IWF device through the first communications network. The packet includes a payload portion, such as voice data, and no header portion associated with the second communications network. The IWF device adds a header portion, associated with the second communications network, to the packet and forwards the packet to the second communications network in accordance with the header portion. Adding the header portion includes identifying a context identifier associated with the packet and determining the header portion to be added to the packet based on the context identifier. The header portion may include respective IP addresses of the subscriber terminal and a destination terminal.

Another aspect of the present invention provides a method for implementing a voice communication between a subscriber terminal and a called party terminal, through a PSTN or an IP network. The subscriber terminal accesses the PSTN and the IP network through a local loop and an associated gateway. The method includes receiving digital voice packets at the gateway through the local loop, such as an AAL2 ATM network. Each voice packet includes voice data, a context identifier associated with the voice packet based on a local loop protocol, and no packet header. The local loop protocol may be a modified BLES protocol. The context identifier is mapped to a communication session. A packet header is added to the voice packet, which includes routing information based on the mapped context identifier. The voice packet is forwarded to the IP network for routing to the called party terminal based on the packet header.

The method may further include receiving signaling data from the subscriber terminal, identifying a called party number based on the signaling data, and determining whether the called party number corresponds to an IP address of the called party terminal. When the called party number corresponds to an IP address, the voice packet is forwarded to the IP network for routing to the called party terminal based on the packet header. When the called party number does not correspond to an IP address of the called party terminal, the voice packet is converted to an analog voice signal, which is forwarded to the PSTN for routing to the called party terminal based on the called party number.

Another aspect of the present invention provides a system for increasing efficiency in a first communications network, such as an ATM network, for a digital data packet originating at a subscriber end-system. The system includes an IWF device that interfaces with the first communications network and a second communications network, such as an IP network. The IWF device receives the packet through the first communications network. The packet includes a payload portion, which may be voice data, and no header portion associated with the second communications network. The IWF device adds a header portion associated with the second communications network to the packet and forwards the packet to the second communications network in accordance with the header portion. The header portion may be added by identifying a context identifier associated with the packet and determining the header portion based on the context identifier. The header portion includes at least IP addresses respectively corresponding to the subscriber terminal and a destination terminal.

Yet another aspect of the present invention provides a system for implementing a voice communication between a subscriber terminal and a called party terminal, through at least one of a PSTN and an IP network. The system includes a local access network, such as an AAL2 ATM network, and a gateway. The local access network receives digital voice packets from the subscriber terminal, in accordance with a local loop protocol. Each voice packet includes voice data, a context identifier associated with the voice packet based on the local loop protocol, and no packet header. The gateway receives the voice packet from the local access network, maps the context identifier to a communication session, and adds a packet header to the voice packet. The packet header includes routing information based on the mapped context identifier. The gateway forwards the voice packet to the IP network for routing to the called party terminal based on the packet header.

The system may also include a gateway controller that receives signaling data from the subscriber terminal, identifies a called party number based on the signaling data, and determines whether the called party number corresponds to an IP address of the called party terminal. When the called party number corresponds to an IP address of the called party terminal, the gateway controller instructs the gateway to forward the voice packet to the IP network for routing to the called party terminal based on the packet header. When the called party number does not correspond to an IP address of the called party terminal, the gateway controller instructs the gateway to convert the voice packet to an analog voice signal and to forward the analog voice signal to the PSTN for routing to the called party terminal based on the called party number.

The various aspects and embodiments of the present invention are described in detail below.

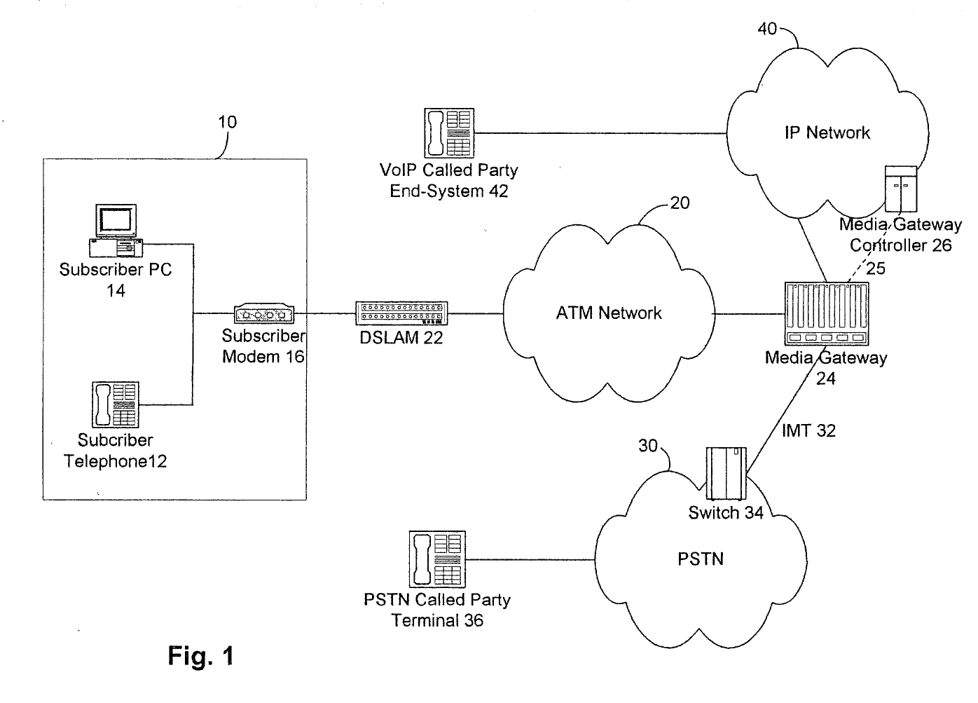

FIG. 1 is a block diagram depicting an exemplary network infrastructure supporting the present invention. As stated above, an embodiment of the present invention enables establishment of high quality connections over the local loop to support VoIP functionality. FIG. 1, in particular, depicts an exemplary ATM network 20 as the local access network through which the subscriber end-system 10 accesses core networks, such as the IP network 40 and the switched PSTN 30 through an interworking function (IWF) device, such as a media gateway 24. The present invention is not limited to ATM networks. The invention may be implemented over any high speed, broadband digital network that transmits voice and data packets, capable of interfacing with the IP network 40 and the PSTN 30. In the depicted embodiment, the ATM network 20 is required to support AAL2, which is particularly suited for packetized voice communications. The QoS required for the AAL2 based service shall be the real-time variable bit rate (rt-VBR) based service over an ATM connection.

The ATM network 20 may include a number of ATM switches (not shown). The ATM network 20 may vary from a single ATM switch to a combination of ATM edge switches, respectively interfacing the IWF devices (e.g., the subscriber modem 16 and the media gateway 24) with a network of core ATM switches. Exemplary ATM switches include the Alcatel 7670 Routing Switch Platform, available from Compagnie Financiére Alcatel of Paris, France. The connections through the ATM network 20 are conventional virtual channel (VC) connections, identified by a virtual path identifier (VPI) and a virtual channel identifier (VCI), which may be set up and torn down on a per communication basis.

In the depicted embodiment of the invention, the subscriber end-system 10 includes a subscriber telephone 12 and a subscriber terminal 14, e.g., a personal computer (PC), which incorporates a web browser, such as Microsoft Internet Explorer, available from Microsoft Corporation, or Netscape Navigator, available from Netscape Communications Corporation. In one embodiment, the subscriber terminal 14 is implemented with an IBM Pentium based PC, running the Linux operating system, available from, for example, Free Software Foundation, Inc., or the Microsoft Windows operating system, and running the Microsoft Internet Explorer, Netscape Navigator or HotJava, available from Sun Microsystems, Inc., web browser software. The subscriber end-system 10 need not be IP aware.

Both the subscriber telephone 12 and the subscriber terminal 14 are connected to a customer premises IWF, such as a subscriber modem 16. The subscriber modem 16 is a digital modem, such as an ADSL interface or a trunk level 1 (T1) interface, that receives analog signals from the subscriber telephone 12 (e.g., voice signals) and converts the analog signals to digital signals. The subscriber modem 16 also incorporates the digital data into voice packets and encapsulates the voice packets into AAL2 ATM cells. The ATM cells are transmitted as 64 kbps pulse code modulated (PCM) signals to the digital subscriber line access multiplexer (DSLAM) 22.

The system may be integrated to the extent that the subscriber modem 16 also receives digital data, video or voice signals from the subscriber terminal 14. Because signals received from the subscriber terminal 14 are already digital and packetized by the subscriber terminal 14, the subscriber modem 16 only encapsulates the packets into the ATM cells, which are subsequently transmitted through the ATM network 20. Likewise, subscriber end-system 10 may include a VoIP telephone, in which case voice signals received by the subscriber modem 16 are already digital and packetized, as are the signals received from the subscriber terminal 14.

Unlike conventional systems, the voice packets of the present invention do not include core network overhead data, such as IP/UDP/RTP headers. For example, a modem in a conventional VoIP system converts analog voice signals to digital packets and adds IP/UDP/RTP headers to the packets prior to encapsulating them into ATM cells. When a computer terminal or VoIP telephone is used, the headers have been added to the voice packets prior to the modem receiving the packets. The IP/UDP/RTP headers provide the call routing information necessary to reach the called party through the IP network, including the IP source and destination addresses, the UDP source and destination ports and the RTP synchronization source field. However, as discussed above, the headers add a considerable amount of data to the packets and consequently reduce the efficiency of the transmission.

By eliminating the IP/UDP/RTP headers, the present invention reduces the total amount of data, increasing the line efficiency of the local loop. The exclusion of the headers enables transmission of a larger payload (e.g., voice data) in each packet or the same payload in a smaller packet. The ability to transmit a larger payload in the same size of packet more efficiently utilizes the available bandwidth, while the ability to transmit the same size of payload in a smaller packet reduces the required bandwidth. In both scenarios, efficiency is increased. Lowering the bandwidth requirements in the local loop can reduce the possibility of network congestion, while increasing quality.

The size of the voice packets, according to various embodiments of the present invention, may vary depending on the voice quality requirements. For example, in one embodiment, the voice payload of each digital voice packet occupies 40 bytes of the packet, which is compatible with the available 44 byte payload of the AAL2 ATM cells. The corresponding voice packet length is 5 milliseconds of PCM, which essentially generates a voice packet every 5 milliseconds of the communication, in accordance with International Telecommunications Union (ITU) telecommunication standard G.711, entitled “Pulse Code Modulation (PCM) of Voice Frequencies,” for example, the disclosure of which is expressly incorporated by reference herein in its entirety. Alternatively, the voice packet may be 10 milliseconds in length, in accordance with adaptive differential pulse code modulation-32 (ADPCM-32).

Alternative embodiments of the invention may include a larger voice packet, such as 80 bytes, which requires an additional ATM cell to transport each voice packet. The 80 byte voice payload involves a larger voice packet length, such as 20 milliseconds of the PCM voice packet. The smaller voice packets, however, increase the voice quality as the packetization process is shorter and the size of the corresponding jitter buffer is reduced at the receiving end of the voice communication. Also, the smaller packets require less bandwidth and potentially enable more than one line to be implemented to the subscriber end-system 10 over the same physical connection. Regardless of size, each voice packet does not include an IP/UDP/RTP header from the subscriber end-system 10, as discussed above.

The DSLAM 22 multiplexes the packetized signals from the subscriber modem 16 with packetized signals from other subscribers to interface with the ATM network 20. The DSLAM 22 may include ATM switch functionality or alternatively, may be co-located with one of the ATM switches of the ATM network 20. An exemplary DSLAM 22, which includes ATM functionality, is the Alcatel 7300 Advanced Services Access Manager, available from Compagnie Financiére Alcatel of Paris, France.

As discussed above, the ATM network 20 interfaces the IP network 40 and the PSTN 30 through the media gateway 24, which terminates the ATM VC. The link protocol governing communications among the subscriber end-system 10, the ATM network 20 and media gateway 24 is BLES, as modified to transmit voice packets through the local loop without IP/UDP/RTP headers, discussed below. BLES is specified, for example, in the ATM Forum specification “Voice and Multimedia over ATM-Loop Emulation Service using AAL2,” AF-VMOA-0145.000 (July 2000), the disclosure of which is expressly incorporated by reference herein in its entirety. BLES is a protocol developed for implementing broadband access through the local loop and generally enables loop interconnections between POTS, ISDN or DSL users and the LEC, in the form of packet-based voice and signaling.

Significantly, the media gateway 24 includes an assignment database that accommodates the modified BLES signaling. In an embodiment, a context identifier (CID) table of the media gateway 24 is modified to identify and store a predetermined range of CIDs assigned to VoIP applications, to be routed in accordance with the present invention. Although conventional BLES signaling includes CIDs that are matched to various applications by a media gateway, current BLES parameters do not specifically include a range of CIDs set aside for VoIP applications according to the present invention. Therefore, the BLES protocol is modified to include the CIDs needed to instruct the media gateway 24 to add IP/UDP/RTP headers to voice packets, for example, by either redefining current CIDs or including additional CIDs.

The media gateway 24 is controlled by a softswitch, such as a media gateway controller 26, which is resided in the IP network 40. The connection between the media gateway 24 and the media gateway controller 26 is a signaling only connection, as indicated by the dashed line 25. The media gateway controller 26 determines whether a called number, entered or dialed by the subscriber at the subscriber end-system 10, has an associated IP address. For example, the media gateway controller 26 accesses a table of telephone numbers and corresponding IP addresses, if any. The media gateway controller 26 is able to determine the called number based on conventional narrowband signaling received by the media gateway 24 from the subscriber end-system 10 over the local loop, either in-band or out-of-band. The narrowband signaling includes, for example, known channel associated signaling (CAS) and common channel signaling (CCS).

The media gateway 24 interfaces with the IP network 40, whenever the called number has an associated IP address, to establish a VoIP connection between the subscriber end-system 10 and the VoIP called party end-system 42. The IP network 40 may be a private IP network, such as a corporate intranet, or the public Internet. When the voice packets are particularly small, e.g., 5 millisecond packet length, with a payload of 40 bytes, the IP network 40 may include routers that are specifically designed to handle the small IP packets, to prevent loss of packets that may adversely affect the quality of the voice communication.

The VoIP called party end-system 42 may be a VoIP capable telephone, although alternative embodiments include an IP capable PC, including a microphone and a speaker to accommodate the voice conversation, or a DTMF telephone, interfaced with an analog-to-digital modem. The interface between the VoIP called party end-system 42 and the IP network 40 is well known. Alternatively, the VoIP called party end-system 42 may likewise be implemented in accordance with the present invention.

The media gateway 24 interfaces with the PSTN 30 through an intermachine trunk 32 and a public switch 34 in the PSTN 30. In an embodiment of the invention, the switch 34 is a conventional class 5 switch, including, for example, 1AESS or 5ESS switches manufactured by Lucent Technologies, Inc.; DMS-100 switches manufactured by Nortel Networks Corporation (Nortel); AXE-10 switches manufactured by Telefonaktiebolaget LM Ericsson, or EWSD switches available from Siemens Information and Communication Networks, Inc. Alternative embodiments of the present invention include any comparable switches incorporated in the PSTN. Whenever the connection from the subscriber terminal 10 is directed to a PSTN called party terminal 36, which may be a DTMF telephone, the packetized voice data is changed to analog signals for routing through the PSTN 30. The process is well known, for example, in conventional voice over DSL processing.

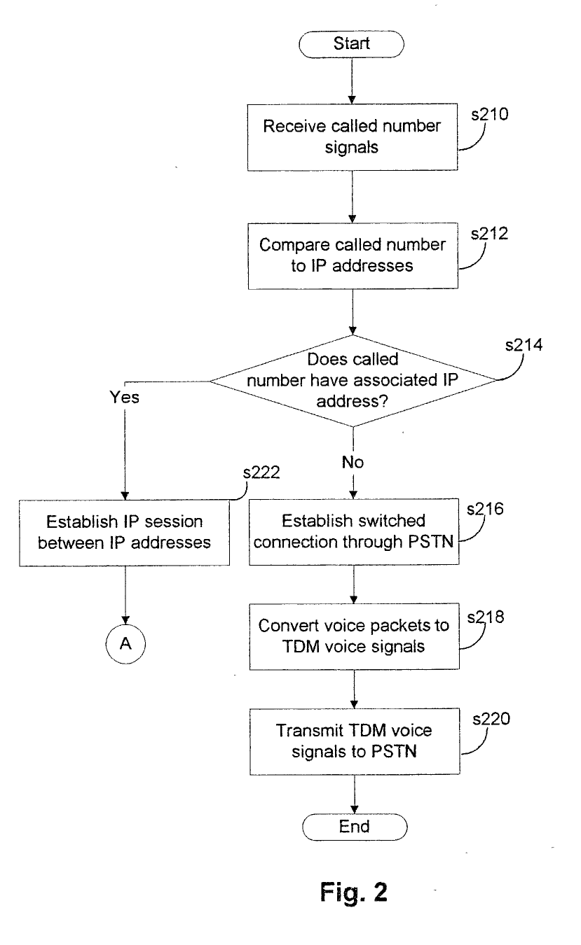

FIG. 2 is a flowchart depicting exemplary application logic for initiating either a VoIP call or a PSTN call from the subscriber end-system 10, depending on whether the called party is configured to receive VoIP communications. At step s210, the media gateway 24 receives the called number signals, input at the subscriber end-system 10 and transmitted across the ATM network 20. As discussed above, the called number signals are received through conventional narrowband signaling, such as CAS and CCS. Data from the narrowband signaling data, including the called number, is forwarded to the media gateway controller 26 using, for example, a session initiation protocol (SIP). The media gateway controller 26 cross-references the called number to a database of IP addresses at step s212. The cross-referencing may involve referencing a previously established table of telephone numbers and associated IP addresses.

At step s214, the media gateway controller 26 determines whether the called number matches an IP address. When there is no associated IP address, it is determined that the called number is accessible only over the PSTN 30, and not the IP network 40. In other words, an end-to-end VoIP connection between the subscriber end-system 10 and the called party is not possible. The media gateway controller 26 therefore instructs the media gateway 24 to establish a connection over the PSTN 30 at step s216, a well known process, to terminate the connection at the terminal associated with the called number, e.g., the PSTN called party terminal 36.

Once the connection is complete, for example, by the PSTN called party terminal 36 going off-hook, the verbal communication between the subscriber end-system 10 and the PSTN called party terminal 36 may begin. As the media gateway receives voice packets from subscriber end-system 10 across the ATM network 20, it converts the voice packets to TDM voice signals at step s218. At step s220, the TDM voice signals are transmitted across the IMT 32 to the switch 34. The switch 34 completes the connection through conventional switching procedures, which may include implementation of advanced intelligent network (AIN) services, to which the subscriber or the called party subscribes. Voice signals received from the PSTN called party terminal 36 are simply handled in reverse (not pictured). The media gateway 24 simply converts the analog voice signals to digital signals, which are packetized, encapsulated in AAL2 cells and transmitted over the ATM network 20 to the subscriber end-system 10.

When the media gateway controller 26 determines at step s214 that the called number matches an IP address, the media gateway controller 26 instructs the media gateway 24 to establish an IP session between the IP address of the subscriber end-system 10 and the VoIP called party end-system 42 at step s222. In an embodiment of the invention, the IP session is established transparently in that the IP session is set up automatically whenever the subscriber attempts to establish a VoIP communication. For example, the IP session may be established based on known “best effort” routing, by which data packets travel through any available combination of routers to ultimately reach the VoIP called party end-system 42. When a router becomes unavailable, for example, due to traffic congestion causing its queue threshold to be exceeded, the data packets simply proceed through a different path. Any comparable IP routing technique may be employed to initiate the IP session between the subscriber terminal 14 and the VoIP called party end-system 42.

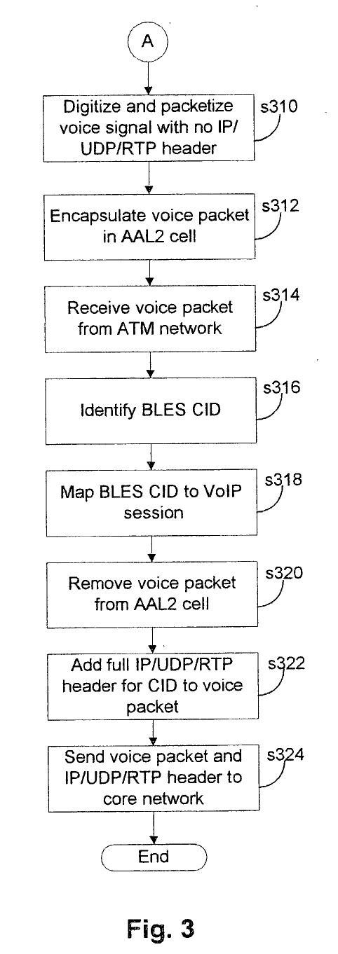

Once the IP session is established, the process proceeds to FIG. 3, which is a flowchart depicting exemplary application logic for routing outgoing VoIP communications through the IP network 40. At step s310 of FIG. 3, the voice signal received from the subscriber telephone 12 or the subscriber terminal 14 is digitized and packetized. As discussed above, the voice packet does not include an IP/UDP/RTP header, but does include a BLES CID that indicates the packet contains no header and may be associated with a VoIP session. At step s312, the voice packet is encapsulated in an AAL2 cell of the ATM network 20. The voice packet is transported toward the media gateway 24 in the ADSL frequency band, routed through the ATM network along the VC established for the session. The media gateway 24 terminates the VC at step s314. Because the VoIP service is connected end-to-end with an individual ATM VC, the ATM network 20 is able to depend on the established bandwidth and to provide the appropriate QoS, when needed.

The media gateway 24 identifies the BLES CID at step s316 and maps the BLES CID to the established VoIP session at step s318. The media gateway 24 also identifies the voice packet as requiring an IP/UDP/RTP header, based on a comparison of the BLES CID identified at step s316 and the pre-established CID assignment table, discussed above. Accordingly, the media gateway 24 removes the voice packet from the AAL2 cell at step s320 and adds a full IP/UDP/RTP header at step s322. The IP/UDP/RTP header includes, for example, the IP address and UDP port of the subscriber end-system 10, the IP address and the UDP port of the VoIP called party end-system 42, and an RTP synchronization source field. The IP/UDP/RTP header may be compressed to enhance efficiency and further enable guaranteed QoS over the IP network 40, accordingly to known header compression techniques.

At step s324, the combined voice packet and IP/UDP/RTP header is transmitted to the IP network 40, which routes the voice packet according to the information in the IP/UDP/RTP header. The packet arrives at the VoIP called party end-system 42, which processes the voice data to enhance the clarity and reliability of the communication. For example, the voice data passes through a jitter buffer, which essentially delays the transmission by a predetermined worst-case delay variable to avoid delivering voice packets out of order or skipping voice packets altogether.

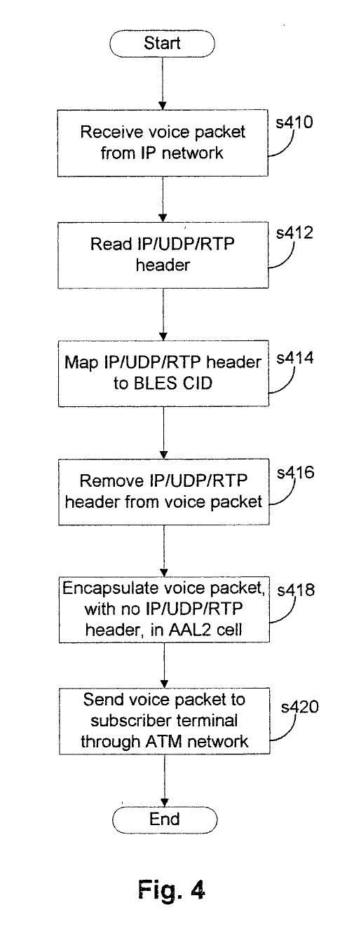

FIG. 4 depicts an exemplary flow of a voice signal initiated at the VoIP called party end-system 42. As discussed above with respect to the subscriber end-system 10, the VoIP called party end-system 42 generates digital voice packets corresponding to the analog voice signals. When the VoIP called party end-system 42 is implemented according to the present invention, the voice packets do not include an IP/UDP/RTP header, which is subsequently added to the voice packet at the media gateway associated with the called party's local loop (not pictured). Otherwise, the voice packets include the IP/UDP/RTP headers to enable return routing through the IP network 40.

Each voice packet routed through the IP network 40 is received by the media gateway 24 at step s410. The media gateway 24 reads the IP/UDP/RTP header at step s412 and maps the IP/UDP/RTP header to the BLES CID, using the CID assignment table, at step s414. Upon identifying the BLES CID, the media gateway 24 determines that the communication proceeds without a header. Therefore, at step s416, the media gateway 24 removes the IP/UDP/RTP header from the voice packet.

The voice packet, without the header, is encapsulated in an AAL2 cell at step s418. At step s420, the AAL2 cell is routed through the ATM network 20 to the subscriber end-system 10 to complete the transmission. Like the VoIP called party end-system 42, the subscriber end-system 10 processes the voice packet to enhance the clarity and reliability of the communication.

Because the present invention relies on modified BLES, the media gateway 24 is able to support VoDSL applications, in addition to VoIP communications, over the IP network 40, increasing the utilization of the media gateway 24. In particular, the media gateway 24 does not convert between the packet voice of VoDSL to TDM voice, required for transmission through the PSTN 30, as presently required for VoDSL transmissions. The VoDSL voice packet simply remains in packet form. Additional voice lines therefore can be supported without consuming significant additional resources of the media gateway 24, such as a digital signal processor, a codec and an echo canceler.

When the media gateway 24 determines that the BLES CID of the voice packet is not included in its CID assignment table as a VoIP application, the media gateway 24 does not assign an IP/UDP/RTP header. With no IP/UDP/RTP header, the voice packet can not be properly routed through the IP network 40. Therefore, the media gateway 24 converts the voice packet to TDM signaling and passes the TDM signaling through the IMT 32 to the switch 34 of the PSTN 30, as discussed above with respect to steps s216-s220 of FIG. 2, regardless of whether the called number has an associated IP address. The subscriber end-system 10 is then able to communicate with the PSTN called party terminal 36.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet-switched network transmission (e.g., G.711, ADPCM-32, RFC 2508, AF-VMOA-0145) and public telephone networks (ATM, DSL, ISDN) represent examples of the state of the art. Such standards are periodically superseded by faster or more efficient equivalents having essentially the same functions. Accordingly, replacement standards and protocols having the same functions are considered equivalents.

What is claimed is:

1. A method for increasing efficiency in a first communications network for a digital data packet originating at a subscriber end-system, the first communications network interfacing with a second communications network through an interworking function (IWF) device, the method comprising:
receiving the packet at the IWF device through the first communications network, the packet comprising a payload portion and no header portion associated with the second communications network;
adding a header portion associated with the second communications network to the packet at the IWF device; and
forwarding the packet to the second communications network in accordance with the header portion.

2. The method for increasing efficiency according to claim 1, the payload portion of the packet comprising voice data.

3. The method for increasing efficiency according to claim 1, the first communications network comprising an asynchronous transfer mode network.

4. The method for increasing efficiency according to claim 3, the second communications network comprising a packet switched data network.

5. The method for increasing efficiency according to claim 4, in which adding the header portion comprises identifying a context identifier associated with the packet and determining the header portion to be added to the packet based on the context identifier.

6. The method for increasing efficiency according to claim 4, in which the header portion comprises at least an internet protocol address of the subscriber terminal and an internet protocol address of a destination terminal.

7. A method for implementing a voice communication between a subscriber terminal and a called party terminal, through at least one of a public switched telephone network (PSTN) and an Internet protocol (IP) network, the subscriber terminal accessing the PSTN and the IP network through a local loop and an associated gateway, the method comprising:
receiving at least one digital voice packet at the gateway, through the local loop, the voice packet comprising voice data, a context identifier associated with the voice packet based on a local loop protocol and no packet header;
mapping the context identifier to a communication session;
adding a packet header to the voice packet, the packet header comprising routing information based on the mapped context identifier; and
forwarding the voice packet to the IP network for routing to the called party terminal based on the packet header.

8. The method for implementing the voice communication according to claim 7, the local loop protocol comprising a modified broadband access loop emulated service protocol.

9. The method for implementing the voice communication, according to claim 7, the local loop comprising an asynchronous transfer mode (ATM) network.

10. The method for implementing the voice communication, according to claim 9, the ATM network comprising an ATM adaption layer type 2.

11. The method for implementing the voice communication, according to claim 7, further comprising:
receiving signaling data from the subscriber terminal;
identifying a called party number based on the signaling data;
determining whether the called party number corresponds to an IP address of the called party terminal;
when the called party number corresponds to an IP address of the called party terminal, forwarding the voice packet to the IP network for routing to the called party terminal based on the packet header; and
when the called party number does not correspond to an IP address of the called party terminal, converting the voice packet to an analog voice signal and forwarding the analog voice signal to the PSTN for routing to the called party terminal based on the called party number.

12. A system for increasing efficiency in a first communications network for a digital data packet originating at a subscriber end-system, the system comprising:
an interworking function (IWF) device that interfaces with the first communications network and a second communications network, the IWF device receiving the packet through the first communications network, the packet comprising a payload portion and no header portion associated with the second communications network, the IWF device adding a header portion associated with the second communications network to the packet and forwarding the packet to the second communications network in accordance with the header portion.

13. The system for increasing efficiency according to claim 12, the payload portion of the packet comprising voice data.

14. The system for increasing efficiency according to claim 12, the first communications network comprising an asynchronous transfer mode network.

15. The system for increasing efficiency according to claim 14, the second communications network comprising an Internet protocol (IP) packet switched data network.

16. The system for increasing efficiency according to claim 15, in which adding the header portion comprises identifying a context identifier associated with the packet and determining the header portion to be added to the packet based on the context identifier.

17. The system for increasing efficiency according to claim 16, in which the header portion comprises at least an IP address of the subscriber terminal and an IP address of a destination terminal.

18. A system for implementing a voice communication between a subscriber terminal and a called party terminal, through at least one of a public switched telephone network (PSTN) and an Internet protocol (IP) network, the system comprising:
a local access network that receives at least one digital voice packet from the subscriber terminal, in accordance with a local loop protocol, the voice packet comprising voice data, a context identifier associated with the voice packet based on the local loop protocol, and no packet header; and
a gateway that receives the voice packet from the local access network, maps the context identifier to a communication session, and adds a packet header to the voice packet, the packet header comprising routing information based on the mapped context identifier, the gateway forwarding the voice packet to the IP network for routing to the called party terminal based on the packet header.

19. The system for implementing the voice communication according to claim 18, the local loop protocol comprising a modified broadband access loop emulated service protocol.

20. The system for implementing the voice communication, according to claim 18, the local access network comprising an asynchronous transfer mode (ATM) network, implemented with an ATM adaption layer type 2.

21. The system for implementing the voice communication, according to claim 18, further comprising:
a gateway controller that receives signaling data from the subscriber terminal, identifies a called party number based on the signaling data and determines whether the called party number corresponds to an IP address of the called party terminal;
when the called party number corresponds to an IP address of the called party terminal, the gateway controller instructs the gateway to forward the voice packet to the IP network for routing to the called party terminal based on the packet header; and when the called party number does not correspond to an IP address of the called party terminal, the gateway controller instructs the gateway to convert the voice packet to an analog voice signal and to forward the analog voice signal to the PSTN for routing to the called party terminal based on the called party number.
